(19) United States
(12) Patent Application Publication
(10) Pub. No.: US 2010/0026968 A1
(43) Pub. Date: Feb. 4, 2010

(54) PROJECTION-TYPE IMAGE DISPLAY APPARATUS

(76) Inventors: Takumi KIJIMA, Tokyo (JP); Kazuo Kadowaki, Tokyo (JP); Takashi Kojima, Tokyo (JP); Kohei Eto, Tokyo (JP)

Correspondence Address: BIRCH STEWART KOLASCH & BIRCH, PO BOX 747, FALLS CHURCH, VA, 22040-0747, US

(21) Appl. No.: 12/508,671

(22) Filed: Jul. 24, 2009

(30) Foreign Application Priority Data
Jul. 29, 2008 (JP) 2008-195507

(51) Int. Cl. G03B 21/10

(52) U.S. Cl. 353/79

(57) ABSTRACT

A projection-type image display apparatus that projects an image on a screen, includes a screen frame that holds the screen; an optical engine base that is coupled to a lower edge of the screen frame; an upper cross brace that extends obliquely backwards from an upper edge of the screen frame; a lower cross brace that extends obliquely backwards from a vertical frame of the screen frame; and a coupling member that couples the upper cross brace with the lower cross brace.

### BACKGROUND OF THE INVENTION

1. Field of the Invention

The present invention relates to a projection-type image display apparatus.

2. Description of the Related Art

There is a constant endeavor to make a low-profile projection-type image display apparatus with a large screen and high image quality by improving the structural strength for achieving a low-profile but large screen, and improving the mounting accuracy of optical components for achieving the high image quality.

For example, a projection-type television receiver is disclosed in Japanese Patent Application Laid-open No. 2002-247480, in which an integrated frame structure of aluminum or iron is used, and optical components such as optical units, mirrors, and a screen, are mounted on the frame to improve the mounting accuracy of the optical components and to prevent an optical path from shifting due to external impact, etc.

Furthermore, a rear-projection type image display apparatus is disclosed in Japanese Patent Application Laid-open No. 2001-305655, in which at least one screen holding member is provided in a holding unit that holds a transparent screen substantially vertically, the screen holding member including a hard material part and at least one soft material part that projects from at least one side wall of the hard material part. The elastic force of the soft material part holds the periphery of the transparent screen, so that deformation of the transparent screen is suppressed. Moreover, fewer parts are required and assembly work is improved.

However, in a large rear-projection type image display apparatus such as one with a 50-inch or larger screen, use of bulky and heavy light source units, optical engine, power circuits, and signal processing circuits is unavoidable, and therefore a proportionally bulky and heavy supporting structure needs to be provided.

### SUMMARY OF THE INVENTION

It is an object of the present invention to at least partially solve the problems in the conventional technology.

According to an aspect of the present invention, there is provided a projection-type image display apparatus that projects an image on a screen. The projection-type image display apparatus includes a screen frame that holds the screen; an optical engine base that is coupled to a lower edge of the screen frame; an upper cross brace that extends obliquely backwards from an upper edge of the screen frame; a lower cross brace that extends obliquely backwards from a vertical frame of the screen frame; and a coupling member that couples the upper cross brace with the lower cross brace.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view schematically illustrating a projection-type image display apparatus according to a first embodiment of the present invention;

FIG. 2 is a schematic diagram of truss structures of the projection-type image display apparatus shown in FIG. 1; and

FIG. 3 is a perspective view schematically illustrating a projection-type image display apparatus according to a second embodiment of the present invention.

### DETAILED DESCRIPTION OF THE PREFERRED EMBODIMENTS

Exemplary embodiments of the present invention are explained in detail below with reference to the accompanying drawings. The present invention is not limited to the embodiments explained here.

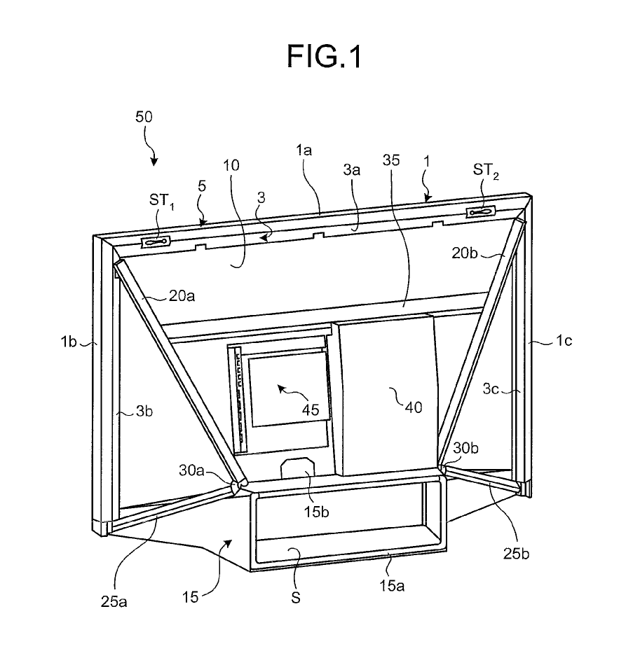

FIG. 1 is a perspective view schematically illustrating a projection-type image display apparatus 50 according a first embodiment of the present invention seen from the back, mainly illustrating a framework thereof. The projection-type image display apparatus 50 includes a screen frame 5, a screen 10, an optical engine base 15, upper cross braces 20a and 20b, lower cross braces 25a and 25b, coupling members 30a and 30b, a horizontal member 35, a light source unit 40, and a television (TV) circuit 45.

The screen frame 5 is a double structure in which a rectangular outer frame 1 and a rectangular inner frame 3 are unified with braces ST₁ and ST₂. The outer frame 1 includes an upper frame 1a, a left vertical frame 1b on the left side in FIG. 1, a right vertical frame 1c on the right side in FIG. 1, and a lower frame (not shown). The inner frame 3 includes an upper frame 3a, a left vertical frame 3b on the left side in FIG. 1, a right vertical frame 3c on the right side in FIG. 1, and a lower frame (not shown).

The screen 10 is a rectangular sheet-like screen that includes, for example, a lenticular lens sheet or a Fresnel lens sheet. The periphery of the screen 10 is fixed to the inner circumference of the inner frame 3 and held by the inner frame 3. Because the inner frame 3 is integrated with the outer frame 1 to form the screen frame 5, in effect, the screen 10 is held by the screen frame 5.

The optical engine base 15 accommodates an optical engine (not shown) in a space S defined by a frame 15a that is arranged around the center in a longitudinal direction. The optical engine base 15 is coupled at a front edge of the optical engine base 15 to a lower edge of the screen frame 5 and extends backwards from the screen frame 5. A guide member 15b is provided above the frame 15a for inserting a light guide (not shown) that optically connects the optical engine and a light source in the light source unit 40. The light source unit 40 is explained later.

The upper cross braces 20a and 20b extend obliquely backwards from an upper edge of the screen frame 5. Specifically, the upper cross brace 20a extends obliquely downwards from an upper edge of the left vertical frame 3b of the inner frame 3, and the upper cross brace 20b extends obliquely downwards from the upper edge of the right vertical frame 3c of the inner frame 3.

The lower cross braces 25a and 25b extend obliquely backwards from the vertical frames of the screen frame 5. Specifically, the lower cross brace 25a extends obliquely backwards from respective lower edges of the left vertical frame 1b of the outer frame 1 and the left vertical frame 3b of the inner frame 3, and the lower cross brace 25b extends obliquely backwards from respective lower edges of the right vertical frame 1c of the outer frame 1 and the right vertical frame 3c of the inner frame 3.

The coupling member 30a couples a rear edge of the upper cross brace 20a and a rear edge of the lower cross brace 25a, and the coupling member 30b couples a rear edge of the upper cross brace 20b and a rear edge of the lower cross brace 25b. The coupling members 30a and 30b are secured to upper corners of the optical engine base 15.

The horizontal member 35 is attached to central portions of the upper cross braces 20a and 20b in the longitudinal direction, reinforcing the upper cross braces 20a and 20b. For example, the light source unit 40 includes laser elements (not shown) that, respectively, oscillate a red light, a green light, and a blue light, and a driving circuit (not shown) that drives the laser elements based on image signals received from the TV circuit 45, and is optically connected to the optical engine by the light guide, and supplies illumination light into the optical engine.

The TV circuit 45 creates image signals and sound signals based on television broadcast waves received by the projection-type image display apparatus 50, and sends the image signals to the optical engine and the light source unit 40 and the sound signals to a speaker (not shown). A casing (not shown) of a predetermined shape is attached to the screen frame 5, covering over the optical engine base 15, the upper cross braces 20a and 20b, the lower cross braces 25a and 25b, the coupling members 30a and 30b, the horizontal member 35, the light source unit 40, and the TV circuit 45.

In the projection-type image display apparatus 50 configured as described above, a display device, such as a liquid crystal panel or a digital light processing (DLP) device inside the optical engine creates an image light based on the illumination light supplied from the light source unit 40 and the image signal received from the TV circuit 45. The image light passes through a projection optical system (not shown) and is projected on the screen 10 from the backside.

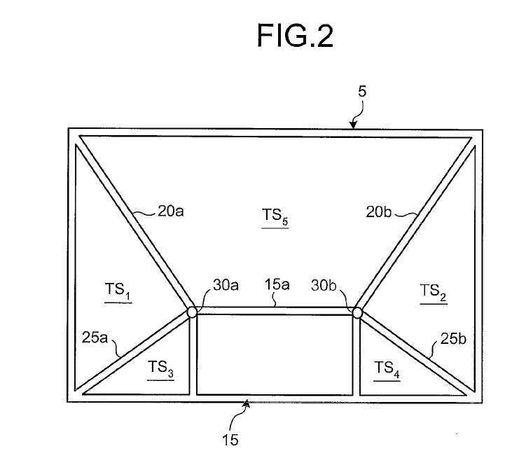

The projection-type image display apparatus 50 can be regarded as having five truss structures in the form of the optical engine base 15, the upper cross braces 20a and 20b, the lower cross braces 25a and 25b, and the coupling members 30a and 30b provided in the rear of the screen frame 5. This point is explained with reference to FIG. 2.

FIG. 2 is a schematic diagram of the truss structures of the projection-type image display apparatus shown in FIG. 1. In the projection-type image display apparatus 50, the left vertical frame of the screen frame 5, specifically, the left vertical frame 3b (see FIG. 1), the upper cross brace 20a, the lower cross brace 25a, and the coupling member 30a form a triangle and hence can be regarded as forming a truss structure TS₁. Similarly, the right vertical frame of the screen frame 5, specifically, the right vertical frame 3c (see FIG. 1), the upper cross brace 20b, the lower cross brace 25b, and the coupling member 30b can be regarded as forming a truss structure TS₂.

The lower cross brace 25a can be regarded as forming a truss structure TS₃ along with the coupling member 30a, a left vertical frame of the frame 15a, and a side of the optical engine base 15 to the left of the frame 15a. Similarly, the lower cross brace 25b can be regarded as forming a truss structure TS₄ along with the coupling member 30b, a right vertical frame of the frame 15a, and a side of the optical engine base 15 to the right of the frame 15a. As a result, the positions of the coupling members 30a and 30b are robustly braced.

Because the positions of the coupling members 30a and 30b are robustly secured, a trapezoidal structure formed by the upper frame of the screen frame 5, specifically, the upper frame 3a (see FIG. 1), the upper cross braces 20a and 20b, and an upper frame of the frame 15a can be regarded as forming one type of truss structure TS₅ that is formed by cutting one vertex portion of a triangle.

A structural strength of the framework of the projection-type image display apparatus 50 having the truss structures TS₁ to TS₅ can be easily increased to a degree that is greater than that required for, for example, withstanding a drop impact. Consequently, even in larger models, fewer parts are required for the framework. Because relative positions of the parts forming the framework can be maintained with high accuracy by the truss structures TS₁ to TS₅, the relative positions of the optical components such as mirrors that form the projection optical system and the screen 10 can be easily maintained. Thus, high structural strength, high accuracy, and lightness can be easily realized in the projection-type image display apparatus 50. Due to high accuracy, a yield rate can be enhanced.

It is basically acceptable for the projection-type image display apparatus according to the present invention if each of the upper cross braces and the lower cross braces coupled by the coupling members form truss structures together with the screen frame. Therefore, for example, the lower cross braces can be configured to extend backwards from the middle of the screen frame, or instead of obliquely backwards, can extend horizontally backwards from the screen frame.

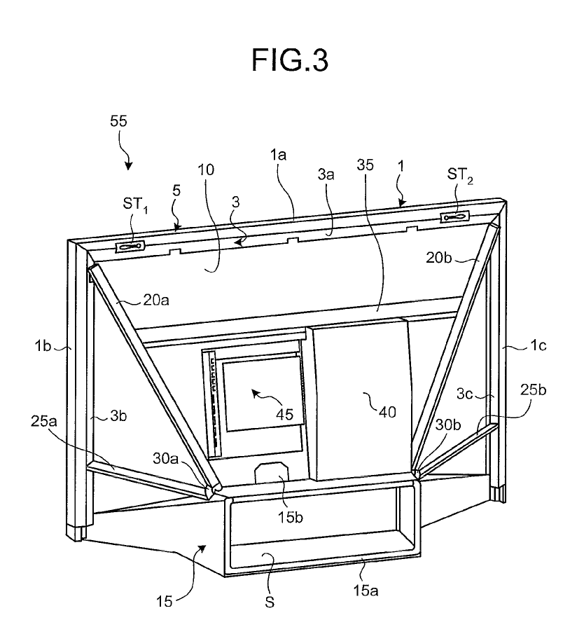

FIG. 3 is a perspective view schematically illustrating a projection-type image display apparatus 55 according to a second embodiment of the present invention, mainly illustrating a framework thereof. The projection-type image display apparatus 55 is identical to the projection-type image display apparatus 50 shown in FIG. 1 in all respects except that the lower cross braces 25a and 25b extend horizontally backwards from the middle of the left vertical frame of the screen frame 5 (that is, from the middle of the left vertical frame 3b) and from the middle of the right vertical frame of the screen frame 5 (that is, from the middle of the right vertical frame 3c), respectively. Components that have the same function as those in FIG. 1 are denoted by the same reference numerals.

The projection-type image display apparatus 55 constructed as described above produces a technical effect similar to that of the projection-type image display apparatus 50 (see FIG. 1) according to the first embodiment. Furthermore, positioning the lower cross braces 25a and 25b horizontally behind the screen frame 5 also produces a technical effect of easily achieving desired manufacturing accuracy of the lower cross braces 25a and 25b and assembly accuracy of the projection-type image display apparatus 55 compared with the projection-type image display apparatus 50.

The present invention is not limited to the embodiments explained here. For example, the screen frame can be of a single structure devoid of the outer frame. The lower frame of the screen frame can be eliminated, irrespective of whether the screen frame has a double structure or a single structure. In a structure where the lower frame is eliminated, a holding member such as a groove can be provided in the front edge of the optical engine base for holding the lower edge of the screen.

The positions where the coupling members that couple the upper cross braces and the lower cross braces are secured in the optical engine base can be appropriately determined according to the shape, etc. of the optical engine base. Exclusive braces for securing the coupling members can also be provided on the top surface of the optical engine base. Alternatively, the exclusive braces for securing the coupling members can be provided separately from the optical engine base. The type of artificial light source used in the light source unit, the place to arrange the light source unit, the structure of the projection optical system, etc., can be changed as required. The present invention is amenable to various alternative forms, modifications, and combinations.

According to an aspect of the present invention, a projection-type image display apparatus that is light and has high structural strength and high accuracy is realized.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A projection-type image display apparatus that projects an image on a screen, the projection-type image display apparatus comprising:
a screen frame that holds the screen;
an optical engine base that is coupled to a lower edge of the screen frame;
an upper cross brace that extends obliquely backwards from an upper edge of the screen frame;
a lower cross brace that extends obliquely backwards from a vertical frame of the screen frame; and
a coupling member that couples the upper cross brace with the lower cross brace.

2. The projection-type image display apparatus according to claim 1, wherein the lower cross brace extends from a middle of the vertical frame of the screen frame.

3. The projection-type image display apparatus according to claim 1, wherein the lower cross brace extends horizontally from the vertical frame of the screen frame.

4. The projection-type image display apparatus according to claim 1, wherein the coupling member is secured to an upper portion of the optical engine base.
